(19) United States
(12) Patent Application Publication
(10) Pub. No.: US 2025/0021059 A1
(43) Pub. Date: Jan. 16, 2025

(54) METHOD FOR CARRYING OUT A SAFETY CHECK OF A MODULAR SAFETY CONTROLLER

(71) Applicant: Pilz GmbH & Co. KG, Ostfildern (DE)

(72) Inventors: Martin KRIEG, Ostfildern (DE); Jochen BAUKNECHT, Ostfildern (DE)

(21) Appl. No.: 18/899,038

(22) Filed: Sep. 27, 2024

Related U.S. Application Data
(63) Continuation of application No. PCT/EP2023/057351, filed on Mar. 22, 2023.

(30) Foreign Application Priority Data
Mar. 31, 2022 (DE) 10 2022 107 717.9

(51) Int. Cl. G05B 9/02; G05B 23/02

(52) U.S. Cl. CPC G05B 9/02; G05B 23/0216

(57) ABSTRACT

A method for carrying out a safety check of a modular safety controller having electronics modules in which safety functions for the safe operation of at least one machine connected to the modular safety controller are implemented, includes: establishing a communication link between the modular safety controller and a test device having a human-machine interface; providing a configuration data set processed by the test device and has information about the electronics modules and about the safety functions of the modular safety controller implemented by the electronics modules; generating a test data set with a plurality of user instructions to be executed sequentially for testing the safety functions of the electronics modules; and, for each of the user instructions, visualizing the user instruction, executing the user instruction, confirming execution of the user instruction, and recording and confirming a machine intervention resulting from the execution of the user instruction.

### CROSS REFERENCE TO RELATED APPLICATIONS

This application is a bypass continuation application of PCT International Application No. PCT/EP2023/057351, filed on Mar. 22, 2023, in the WIPO, the international application being based upon and claiming the benefit of priority from German application No. 10 2022 107 717.9 filed on Mar. 31, 2022, the entire contents of which are hereby incorporated by reference.

### TECHNICAL FIELD

The present disclosure relates to a method for carrying out a safety check of a modular safety controller having a plurality of electronics modules in which safety functions for the safe operation of at least one machine or technical system which is connected to the modular safety controller, are implemented.

### BACKGROUND

Modular safety controllers are known from the prior the art in various embodiments. They are used in particular to safely bring machines or technical systems into a state that is safe for people when a dangerous situation occurs. For this purpose, corresponding signals from signal generators, which can be, for example, emergency off switches, emergency stop switches, light grids, light curtains, safety mats, protective door position switches, 3D laser scanners, etc., are received on the input side and safely evaluated. On the output side, one or more safe output contacts of an output circuit are controlled. When a dangerous situation occurs, these output contacts are used to control actuators such as contactors, valves, etc. such that a machine or technical system connected to them can be brought into a state that is safe for people.

Such modular safety controllers comprise several electronics modules that are arranged in at least one module row and have certain functionalities. The modular design of a safety controller creates the possibility of an application-specific configuration by individually assembling several electronic modules, wiring them together and configuring them such that they together provide the modular safety controller with the desired safety functions. Examples of electronics modules from which modular safety controllers with very different safety functions can be constructed include, inter alia, input modules that can receive and, if necessary, process input signals from one or more signal generators, such as, for example, input signals from sensors or emergency control devices, output modules that can output signals to one or more actuators connected to them, combined input and output modules (so-called I/O modules), control modules that can control the assignment of input to output modules, as well as interface modules, communication modules, fieldbus controllers, fieldbus couplers, etc.

The configuration of a modular safety controller can be carried out by a user, for example, using a configuration tool that has a graphical user interface. This enables the user to select the electronics modules required for the specific application of the safety controller from a plurality of electronic modules. The configuration is then stored in a configuration database as a configuration data set, which comprises not only the module information but also information about all safety functions of the modular safety controller.

When manufacturing a modular safety controller, the electronics modules are arranged in the at least one row of modules based on the configuration data set and are wired accordingly and set up so that they can provide the functionalities required for the specific application under safety aspects.

After the modular safety controller has been installed at the place of use, it is necessary to carry out a safety check in order to be able to ensure that the safety controller functions correctly when interacting with a machine or technical system connected to it.

EP 3 499 324 A1 discloses a method for verifying a configuration of a safety controller. The configuration is created on an external input device, such as, for example, a computer or smartphone, and transferred to the safety controller. The configuration implemented in this way is displayed on the input device so that a user can confirm it. The configuration is divided into sub-configurations that are verified.

### SUMMARY

It is an object to disclose a method for carrying out a safety check of a modular safety controller by which the checking process can be carried out by a user in a particularly simple, intuitive and safe manner.

A method according to the disclosure for carrying out a safety check of a modular safety controller having a plurality of electronics modules in which safety functions for the safe operation of at least one machine which is connected to the modular safety controller, are implemented, comprises the steps of:
S1) establishing a communication link between the modular safety controller and a test device which provides a human-machine interface,
S2) providing a configuration data set which is processed by the test device and has information about the electronics modules and about the safety functions of the modular safety controller, which are implemented by the electronics modules,
S3) generating a test data set with a plurality of specified user instructions to be executed sequentially for testing the functions, in particular the safety functions, of the electronics modules,
S4) visualizing one of the user instructions, executing the user instruction in question and confirming the execution of this user instruction,
S5) recording and confirming at least one machine intervention resulting from the execution of the user instruction in method step S4),
S6) repeating steps S4) and S5) until the execution of all user instructions and all resulting machine interventions have been confirmed, and
S7) automatically generating a digital test report from the confirmations of the executed user instructions and the resulting machine interventions, and storing the test report together with a unique identification code of the safety controller in a non-volatile storage device.

By the method according to the disclosure, a user is guided in an automated process through all the test steps required for the safety check of the modular safety controller in a manner of a digital check list which is to be processed sequentially. The execution of all user instructions and the resulting machine interventions are automatically logged and stored and can thus form at least part of a digitally accessible machine documentation in the form of the digital test report.

The term “machine interventions” shall be understood to mean in the present case all reactions of the at least one machine or technical system connected to the safety controller and their actuators and signal generators to the execution of the user instructions specified in the test data set.

The test device can be, for example, a computer, in particular a portable computer, or a tablet computer or a mobile phone (smartphone). The test device executes appropriate test software by which parts of the method according to the disclosure are executed. The test device can optionally be designed such that it can also execute a software-based configurator for configuring the modular safety controller and/or program the modular safety controller.

In a preferred embodiment, it is proposed that the user instructions are visualized by a display device of the human-machine interface. This makes it particularly easy for a user to record and implement the user instructions.

In a particularly preferred embodiment, it is proposed that the execution of the user instructions and the machine interventions are confirmed by a user through inputs into an input device of the human-machine interface. In this way, all instructions executed by the user that trigger machine interventions are acknowledged.

The human-machine interface can, for example, comprise a touch-sensitive display device with an integrated input device. This makes the human-machine interface particularly easy and intuitive to operate.

In one embodiment, it can be provided that at least some of the user instructions comprise setting potentiometer settings of the electronics modules and/or reading preset potentiometer settings of the electronics modules and/or activating at least one signal generator.

In one embodiment, it is possible for the at least one machine intervention resulting from the execution of the user instruction in method step S4) to be recorded by the user and confirmed by the human-machine interface.

In an alternative embodiment, it can also be provided that the at least one machine intervention resulting from the execution of the user instruction in method step S4) is recorded and confirmed in an automated manner by the modular safety controller. This confirmation is then transmitted to the test device, preferably via the communication link.

In an advantageous embodiment, it is proposed that the test data set is generated in an automated manner from the configuration data set by the test device.

In order to further simplify carrying out the method, it can be provided in one embodiment that establishing the communication link between the modular safety controller and the test device is initiated by scanning an optoelectronically readable code which is attached to the modular safety controller, by a camera of the test device. This embodiment is particularly advantageous if the test device is a tablet computer or a mobile phone (smartphone) with an integrated camera. The optoelectronically readable code can in particular be a two-dimensional code.

In one embodiment, it is possible that a replacement verification is carried out when replacing one of the electronics modules.

The method presented here for carrying out a safety check of a modular safety controller makes it possible in particular to check all potentiometer settings, wiring and safety functions of the modular safety controller.

### BRIEF DESCRIPTION OF THE DRAWINGS

Further features and advantages of exemplary embodiments of the disclosed method are described below with reference to the drawings.

FIG. 1 shows a schematic representation of a system for carrying out a safety check of a modular safety controller,

FIG. 2 shows a schematic representation illustrating the basic course of action of the method.

### DETAILED DESCRIPTION

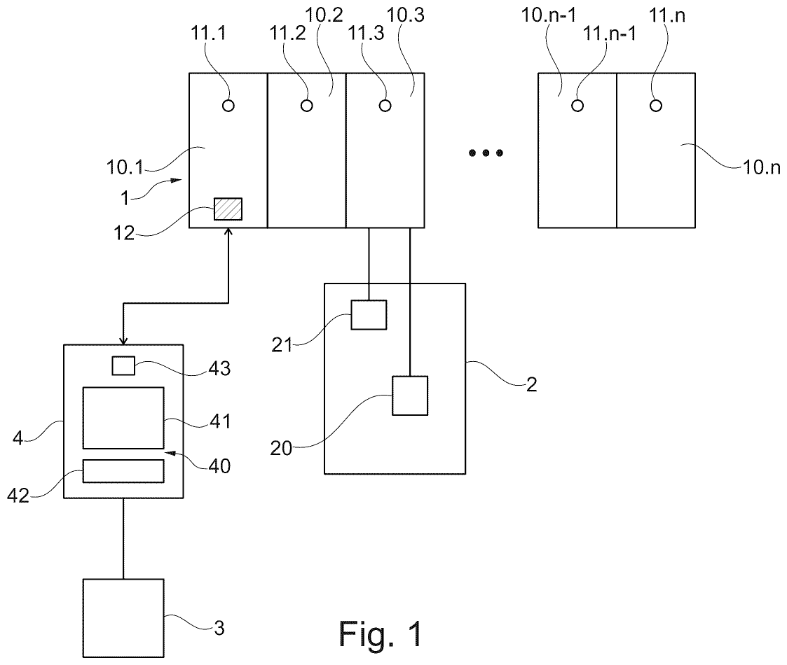

Before details of a method for carrying out a safety check of a modular safety controller 1 are explained in more detail below, the basic structure of a modular safety controller 1 will first be described with reference to FIG. 1. Modular safety controller 1 is connected to at least one machine 2 (or technical system) which has at least one actuator 20 and at least one signal generator 21. An example of a machine 2 that can be operated by modular safety controller 1 is an industrial robot.

A machine 2 often also has several actuators 20 and several signal generators 21 that are connected to modular safety controller 1. In many applications, several machines 2 are connected to a modular safety controller 1 which controls them.

Modular safety controller 1 has a plurality n of electronics modules 10.1-10.n, which are arranged in at least one row of modules and which are electrically wired to one another accordingly and connected to machine 2. A first electronic module 10.1 preferably forms a central control module of modular safety controller 1 and is often also referred to as a head module. The remaining electronics modules 10.2-10.n are selected from a plurality of different electronic module types depending on the application. The remaining electronics modules 10.2-10.n can be, for example, input modules that can safely receive and, optionally, process input signals from one or more signal generators 21, such as, for example, input signals from sensors, signaling devices or emergency command devices, output modules that can safely output output signals to one or more actuators 20 connected to them, combined input and output modules (so-called I/O modules) that have inputs and outputs, as well as interface modules, fieldbus controllers, fieldbus couplers, etc. The number and type of the electronics modules 10.1-10.n used depends directly on the intended use and application of modular safety controller 1 and in particular also on the safety level to be achieved.

In general, the task of modular safety controller 1 is to safely switch off actuators 20 connected to modular safety controller 1 when a dangerous situation occurs which is detected by at least one of signaling devices 21—i.e., by at least one of the sensors, signaling devices or emergency command devices—and to reactivate them after the dangerous situation has ended.

At least some of electronics modules 10.1-10.n of modular safety controller 1 have one or more potentiometers 11.1-11.n, in particular detent potentiometers, by which electrical resistance values affecting functions, in particular safety-related functions, of modular safety controller 1 and machine 2 connected thereto, can be set and are also changeable. For example, potentiometers 11.1-11.n can be used to set or change switch-on and/or switch-off delays of machine 2.

For reasons of simplicity and in order not to over-complicate the following representation, after this general functional description of modular safety controller 1, it shall be assumed below that an actuator 20 and a signal generator 21 of a single machine 2 are connected to modular safety controller 1.

Modular safety controller 1 is configured by a user depending on the intended use, preferably by a software-based configurator. The configuration process can be carried out, for example, by a web-based configurator. The configuration of modular safety controller 1 is stored in a retrievable manner as a configuration data set in a non-volatile storage device 3. Modular safety controller 1 is manufactured based on the configuration data set, which contains all configuration information. Potentiometers 11.1-11.n can be preset during manufacture to simplify subsequent installation of modular safety controller 1 at the place of use.

After delivery of modular safety controller 1 and after connection of modular safety controller 1 to machine 2, it is necessary to check the safety functions of modular safety controller 1 before starting production operation. This check of the safety functions is carried out by a test device 4. Test device 4 can be, for example, a stationary computer or a portable computer, in particular a laptop computer, or a tablet computer or a smartphone. By test device 4, appropriate test software can be executed which supports a user in checking the safety functions of modular safety controller 1 and ensures that all safety checks to be processed are carried out, acknowledged and also logged after completion of the tests. Test device 4 can optionally be designed so that it can also execute the software-based configurator and/or program modular safety controller 1.

Test device 4 has a human-machine interface 40 that enables interaction with a user who carries out the safety check. Human-machine interface 40 has a display device 41 by which information and data of various kinds can be visualized to the user. Furthermore, human-machine interface 40 has at least one input device 42 by which the user can make various user inputs. Display device 41 can be designed to be touch-sensitive-especially when test device 4 is designed as a tablet computer or smartphone-so that the functions of the at least one input device 42 are integrated into display device 41.

In the present case, the configuration data set of modular safety controller 1 is stored decentrally in a non-volatile storage device 3 designed as cloud storage. In principle, the configuration data set of modular safety controller 1 can also be stored differently. In this context, non-volatile storage media should be mentioned, which can be integrated into test device 4 or can be connected at least temporarily to test device 4 via an interface. Furthermore, the configuration data set can be stored on a local server which test device 4 can access via a wired or wireless network connection.

Test device 4 is designed to import and process the configuration data set that defines the configuration of modular safety controller 1 in order to generate a configuration-specific test data set therefrom. The test data set comprises the operating inputs to be made by a user during the safety check of modular safety controller 1, such as, for example, the settings to be made of the potentiometers of electronics modules 10.1-10.n of modular safety controller 1 to carry out the safety check. If the settings of the potentiometers, which are in particular detent potentiometers, have already been made by the manufacturer of modular safety controller 1, the test data set can comprise information on the target positions of the potentiometers.

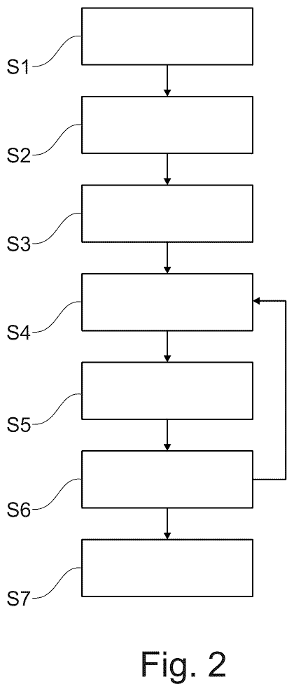

Details of the method for carrying out a safety check of modular safety controller 1, to which at least one machine 2 is connected, will be explained in more detail below with further reference to FIG. 2.

In a step S1), a communication link is established between modular safety controller 1 and test device 4. This can be a wired or wireless communication link. Establishing the communication link between modular safety controller 1 and test device 4 can, for example, be initiated by scanning an optoelectronically readable code 12, which is attached to modular safety controller 1, by a camera 43 of test device 4. This makes establishing the communication link particularly easy and intuitive.

In a step S2), test device 4 is provided with a configuration data set by accessing storage device 3, which configuration data set is processed by test device 4 and has information about electronics modules 10.1-10.n and about the safety functions of modular safety controller 1, which are implemented by electronics modules 10.1-10.n. The configuration data set can, for example, be stored in non-volatile storage device 3 in a retrievable manner together with a unique identification code of modular safety controller 1, in particular with a unique serial number.

In a step S3), a test data set with a plurality of specified user instructions to be executed sequentially for testing the safety functions of electronics modules 10.1-10.n is generated. Preferably, the test data set is generated by test device 4 in an automated manner from the configuration data set of modular safety controller 1 previously imported by storage device 3. The user instructions, which are to be executed sequentially, tell the user in the form of a digital checklist how the safety check of modular safety controller 1 is to be carried out.

In a step S4), one of the user instructions is visualized by display device 41 of the human-machine interface 40. The respective user instruction is executed by the user. Subsequently, the execution of this user instruction is confirmed.

At least some of the user instructions may comprise setting potentiometer settings of electronics modules 10.1-10.n and/or reading preset potentiometer settings, in particular potentiometer settings preset by the manufacturer, of electronics modules 10.1-10.n and/or activating signal generator 21.

The at least one machine intervention resulting from the execution of the user instruction in method step S4) is recorded and confirmed by the user in a step S5). Alternatively, it is also possible that the at least one machine intervention resulting from the execution of the user instruction in method step S4) is recorded by modular safety controller 1 in step S5) and confirmed to test device 4 via the existing communication link.

In a step S6), steps S4) and S5) are repeated until all user instructions and all resulting machine interventions have been confirmed.

In a step S7), a digital test report is automatically generated by test device 4 from the confirmations of the executed user instructions and from the resulting machine interventions. This test report is stored in a retrievable manner in the non-volatile storage device 3 or in another non-volatile storage medium together with a unique identification code of modular safety controller 1, in particular with the unique serial number of modular safety controller 1. The test report then forms part of the machine documentation.

The method presented here for carrying out a safety check of modular safety controller 1 makes it possible to check all potentiometer settings, wiring and safety functions of modular safety controller 1.

In case of replacement of one of electronics modules 10.1-10.n, a replacement verification can also be carried out by the method.

What is claimed is:

1. A method for carrying out a safety check of a modular safety controller having a plurality of electronics modules in which safety functions for safe operation of at least one machine which is connected to the modular safety controller are implemented, the method comprising:
S1) establishing a communication link between the modular safety controller and a test device having a human-machine interface;
S2) providing a configuration data set that is processed by the test device and has information about the electronics modules and about the safety functions of the modular safety controller, which are implemented by the electronics modules;
S3) generating a test data set with a plurality of specified user instructions, which are to be executed sequentially for testing the safety functions of the electronics modules;
S4) visualizing a user instruction that is one of the user instructions, executing the user instruction and confirming execution of the user instruction;
S5) recording and confirming at least one machine intervention resulting from the execution of the user instruction;
S6) repeating S4) and S5) for others of the user instructions until the execution of all of the user instructions and all resulting machine interventions have been confirmed; and
S7) automatically generating a digital test report from confirmations of the executed user instructions and the resulting machine interventions, and storing the digital test report together with a unique identification code of the modular safety controller in a non-volatile storage device.

2. The method of claim 1, wherein the user instructions are visualized by a display device of the human-machine interface.

3. The method of claim 1, wherein the execution of the user instructions and the resulting machine interventions are confirmed by a user through inputs into an input device of the human-machine interface.

4. The method of claim 1, wherein at least some of the user instructions comprise setting potentiometer settings of the electronics modules and/or reading preset potentiometer settings of the electronics modules and/or activating at least one signal generator of the machine.

5. The method of claim 1, wherein the at least one machine intervention resulting from the execution of the user instruction in S4) is recorded and confirmed by the user.

6. The method of claim 1, wherein the at least one machine intervention resulting from the execution of the user instruction in S4) is recorded and confirmed by the modular safety controller.

7. The method of claim 1, wherein the test data set is generated in an automated manner from the configuration data set by the test device.

8. The method of claim 1, wherein establishing the communication link between the modular safety controller and the test device is initiated by scanning an optoelectronically readable code which is attached to the modular safety controller, by a camera of the test device.

9. The method of claim 1, wherein a replacement verification is carried out when replacing one of the electronics modules.
